(19) United States
(12) Patent Application Publication
(10) Pub. No.: US 2005/0246384 A1
(43) Pub. Date: Nov. 3, 2005

(54) Systems and methods for passing data between filters

(75) Inventors: Oliver Foehr, Mercer Island, WA (US); Khaled S. Sedky, Sammamish, WA (US); Harvinder Pal Singh, Bellevue, WA (US); Feng Yue, Sammamish, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/912,794

(22) Filed: Aug. 6, 2004

Related U.S. Application Data
(60) Provisional application No. 60/567,679, filed on May 3, 2004.

(51) Int. Cl. G06F 7/00

(52) U.S. Cl. 707/200

(57) ABSTRACT

The described systems and methods are directed at enabling two filters to pass data between them in an efficient manner. In one aspect, an interface is provided to a filter for writing data associated with a file. The interface enables the filter to write data to a virtual file container simulated by the interface. The interface also enables another filter to read the data from the simulated file container. In this manner, an actual file container stored in a disk drive may not have to be created to pass data between filters.

### CLAIM OF PRIORITY

This application claims the benefit of U.S. Provisional Application No. 60/567,679, filed May 3, 2004.

### TECHNICAL FIELD

The systems and methods discussed herein relate to data handling.

### BACKGROUND OF THE INVENTION

Elements in files that are generated by advanced application programs are becoming increasingly complex. To properly print files with these complex elements, printers have to be specially configured to accurately and efficiently process the elements. Printers that are not made with such configuration are often referred to as legacy printers. Legacy printers are typically incapable of printing files with complex elements without reconfiguration and extensive processing to convert the file to a bitmap format.

Thus, there is a need for an efficient and effective method to enable a legacy printer to process files with complex elements.

### SUMMARY OF THE INVENTION

The systems and methods discussed herein enable two filters to pass data between them in an efficient manner. In one aspect, an interface is provided to a filter for writing data associated with a file. The interface enables the filter to write data to a virtual file container simulated by the interface. The interface also enables another filter to read the data from the simulated file container. In this manner, an actual file container stored in a disk drive may not have to be created to pass data between filters.

### BRIEF DESCRIPTION OF THE DRAWINGS

FIG. 1 is an example of a block diagram illustrating a production device and a utilization device with respect to a file package.

FIG. 2 is an example of a block diagram of the production device providing the file package to utilization devices under different usage cases for different types of utilization devices.

FIG. 3 illustrates example filters that may be included in the converter module shown in FIG. 2.

FIG. 4 shows a system for passing file data between filters in a filter pipeline.

FIG. 5 shows another system for passing file data between filters in a filter pipeline.

FIG. 6 shows an example process that may be used to provide an interface to filters in a pipeline for writing file data.

FIG. 7 shows an example process that may be used to provide an interface to filters in a pipeline for reading file data.

FIG. 8 illustrates an example computing device within which the described systems and methods can be either fully or partially implemented.

### DETAILED DESCRIPTION

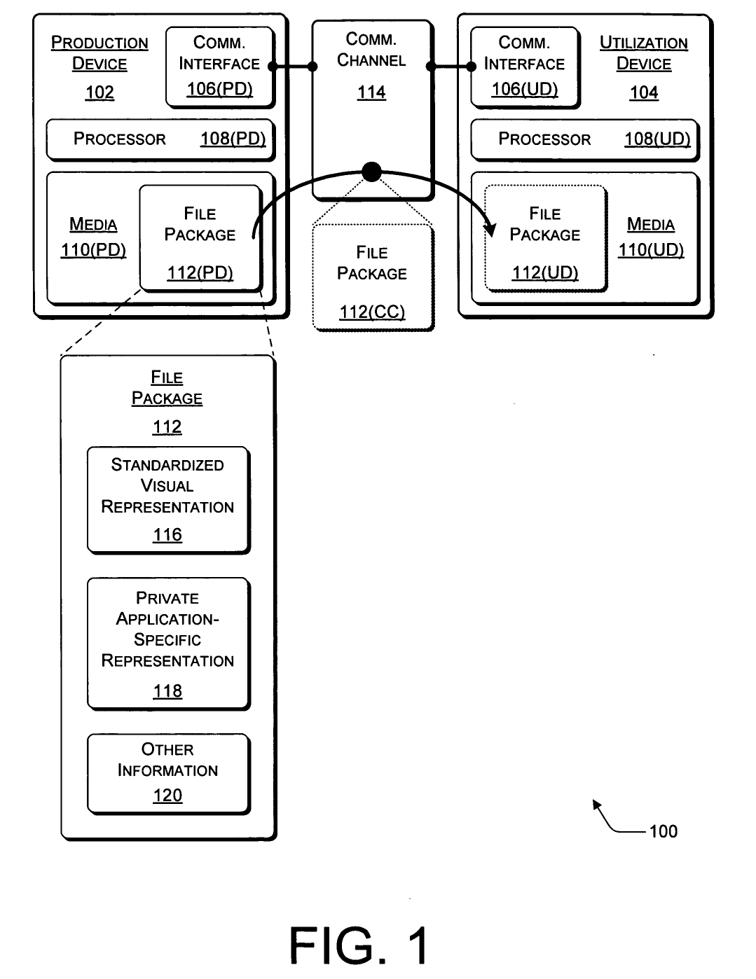

FIG. 1 is an example of a block diagram 100 illustrating a production device 102 and a utilization device 104 with respect to a file package 112. Production device 102 is capable of producing file package 112. Production device 102 is adapted to provide file package 112 to utilization device 104 over a communication channel 114 for utilization by utilization device 104.

As illustrated, each of production device 102 and utilization device 104 include one or more processors 108, at least one media 110, and a communication interface 106 that is coupled to communication channel 114. Specifically, production device 102 includes a processor 108(PD), media 110(PD), and a communication interface 106(PD). Similarly, utilization device 104 includes a processor 108(UD), media 110(UD), and a communication interface 106(UD).

Media 110 typically includes processor-executable instructions that are executable by processor 108 to effectuate functions of devices 102 and 104. Media 110 may be realized as storage or transmission media, volatile or non-volatile media, removable or non-removable media, some combination thereof, and so forth. For example, media 110 may be realized as (i) a volatile random access memory (RAM), (ii) a non-volatile disk-based memory, (iii) a transmission medium, and/or (iv) a propagating signal. Communication channel 114 may be comprised of one or more wireless or wired links that directly interconnect communication interfaces 106 or that indirectly interconnect them across one or more networks (not explicitly shown). Additional details and examples of devices, processors, media, communication mechanisms, and so forth are described further below with reference to FIG. 12.

In a described implementation, file package 112 includes a standardized visual representation 116, a private application-specific representation 118, and other information 120. Standardized visual representation 116 and private application-specific representation 118 can exist in parallel within a single file package 112. Standardized visual representation 116 includes data that enables display of the content in a platform independent manner using, for example, a platform-independent application viewer (not shown in FIG. 1). Private application-specific representation 118 includes data that enables display (and manipulation) of the content using, for example, a proprietary internal format. When the various parts of file package 112 are bundled into a single file, such a single file may be considered a container.

Although shown separately as discrete units, standardized visual representation 116 and private application-specific representation 118 may actually be at least partially overlapping and interrelated. In other words, they may share content information and/or formatting data. Other information 120 represents any additional information and/or metadata included in file package 112 that may be useful for or related to authorship information, version/change tracking, routing information, other visual or non-visual representations, printing information, and so forth.

As illustrated, production device 102 produces file package 112(PD). Production device 102 transmits file package 112(PD) across communication channel 114 via communication interface 106(PD). File package 112(CC) propagates along communication channel 114. Utilization device 104 receives file package 112(UD) through communication channel 114 via communication interface 106(UD). Upon receipt, utilization device 104 may utilize file package 112(UD) depending on the intended use and/or capabilities of utilization device 104. For example, utilization device 104 may be capable of printing, displaying/viewing, distributing, archiving, etc. file package 112(UD). Although not so illustrated, an application (e.g., a file-package-capable viewer) on production device 102 may utilize file package 112.

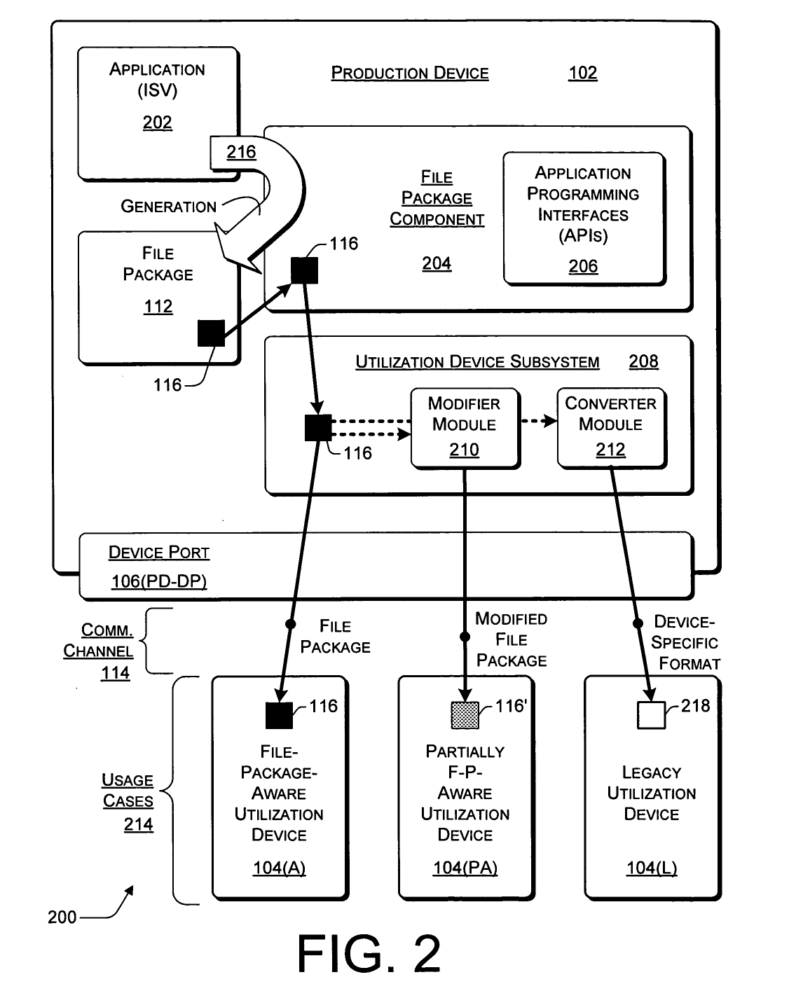

FIG. 2 is an example of a block diagram 200 of production device 102 providing file package 112 to utilization devices 104 under different usage cases 214 for different types of utilization devices 104. Examples of three different usage cases 214 are shown for three different utilization devices 104. These three utilization devices 104 are: a file-package-aware utilization device 104(A), a partially file-package-aware utilization device 104(PA), and a legacy utilization device 104(L). Although three usage cases 214 are illustrated and described, there may alternatively be more or fewer different types of utilization devices 104.

As illustrated, production device 102 includes an application 202, a file package component 204, and a utilization device subsystem 208. Production device 102 also includes a device port 106(PD-DP) implementation of a communication interface 106(PD). By way of utilization device subsystem 208, production device 102 sends file package 112, or at least a version or portion thereof, to utilization devices 104 over communication channel 114 via device port 106(PD-DP).

In a described implementation, application 202 is an application of an independent software vendor (ISV), at least with respect to file package 112, file package component 204, and related features. Consequently, application 202 generates 216 file package 112 using file package component 204. For example, application 202 may make one or more calls to application programming interfaces (APIs) 206 of file package component 204 in order to generate 216 standardized visual representation 116 of file package 112, other information 120 (of FIG. 1), and/or additional parts of file package 112. APIs 206 may alternatively be implemented fully or partially separately from file package component 204. Although not explicitly indicated in FIG. 2, application 202 may access file package 112 after generation 216 thereof.

Standardized visual representation 116 of file package 112 is represented diagrammatically as a black square 116 in block diagram 200. When file package 112 is to be provided to a utilization device 104 (e.g., as requested by application 202), file package component 204 accesses file package 112. In this example, file package component 204 extracts standardized visual representation 116 from file package 112 and forwards standardized visual representation 116 to utilization device subsystem 208. Alternatively, file package component 204 may forward other or additional parts, including all parts, of file package 112 to utilization device subsystem 208. The forwarding may also be effectuated directly by application 202 using APIs 206.

Generally, utilization device subsystem 208 is capable of handling file packages 112, or at least standardized visual representations 116. Specifically, utilization device subsystem 208 is adapted to provide at least a portion of file package 112 to a given utilization device 104 in dependence on the corresponding usage case 214. To this end, utilization device subsystem 208 includes a modifier module 210 and a converter module 212.

File-package-aware utilization device 104(A) is capable of understanding and handling file package 112 technology. In other words, file-package-aware utilization device 104(A) is capable of consuming or properly digesting file packages 112. Consequently, utilization device subsystem 208 forwards standardized visual representation 116 and additional parts, including all parts of file package 112, to file-package-aware utilization device 104(A) without changes thereto via device port 106(PD-DP) and across communication channel 114.

However, one or more changes to standardized visual representation 116 are made prior to forwarding it to partially-file-package-aware utilization device 104(PA). Partially-file-package-aware utilization device 104(PA) is capable of understanding and handling a subset of and/or non-standard file package 112 technology. Specifically, modifier module 210 modifies standardized visual representation 116 to produce a modified standardized visual representation 116′. Modifier module 210 is adapted to rearrange information of file package 112, to remove information to create a backward-compatible version of standardized visual representation 116, and so forth. This modified standardized visual representation 116′ is forwarded from utilization device subsystem 208 to partially-file-package-aware utilization device 104(PA) via device port 106(PD-DP) and across communication channel 114.

On the other hand, some utilization devices 104 can neither understand nor otherwise handle file packages 112. For example, legacy utilization device 104(L) is incompatible with file package 112. Consequently, utilization device subsystem 208 uses converter module 212 to convert standardized visual representation 116 to a device-specific format representation 218 that is compatible with legacy utilization device 104(L). Device-specific format representation 218 is forwarded from utilization device subsystem 208 to legacy utilization device 104(L) via device port 106(PD-DP) and across communication channel 114. For this usage case 214, legacy utilization device 104(L) is unaware that device-specific format representation 218 originated from part of a file package 112. In these manners, file packages 112 can be effectively utilized directly or indirectly by various utilization devices 104 of various usage cases 214.

Generally, utilization devices 104 may be displaying/viewing devices, archiving devices, distributing devices, printing devices, some combination thereof, and so forth. However, in a described implementation, utilization devices 104 are printing devices. In a printing device 104 implementation, application 202 may be a word processing program, a spreadsheet program, or a slide show program, and so forth. Additionally, utilization device subsystem 208 may be realized as a printing subsystem (e.g., a spooler), and device port 106(PD-DP) may be realized as a parallel port, a Universal Serial Bus (USB) port, or a network interface, and so forth. Accordingly, device-specific format 218 may be realized as a Postscript file, a printer control language (PCL) file, or a rasterized bit map information file, and so forth.

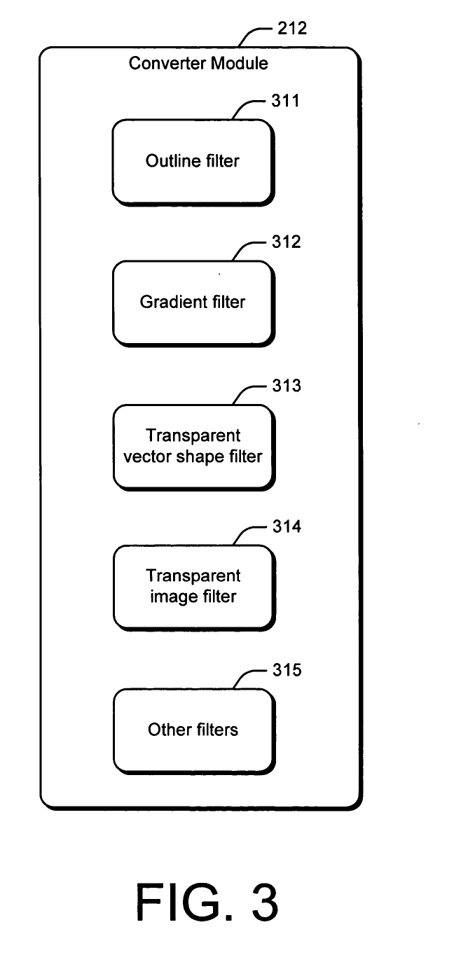

FIG. 3 illustrates example filters that may be included in the converter module 212 shown in FIG. 2. A file may include complex elements that cannot be readily printable by a legacy printer, such as legacy utilization device 104(L). Converter module 212 is configured to process the file and send data that is usable by a legacy printer to print the file.

As shown in FIG. 3, converter module 212 includes filters 311-315, which form a filter pipeline. Each of the filters 311-315 is configured to convert complex elements in a file that cannot be effectively processed by a legacy printer to simpler elements that the printer can efficiently print. For example, outline filter 311 is configured to process elements with complex outlines. Outline filter 311 converts the complex outline of an element to simple primitives that can be handled by a legacy printer. Simple primitives may include lines, polygons, areas, vector shape elements, and the like.

Gradient filter 312 is configured to process elements with complex gradients. Gradient filter 312 converts the complex gradient into multiple polygons with fill colors that approximate the gradient.

Transparent vector shape filter 313 is configured to process vector shape elements with transparency. An element with transparency (e.g. alpha value less than one) allows another element that is overlapped by the element with transparency to be partially shown. The region of the overlapped element covered by the element with transparency typically has a color that is between the two elements. For example, if the transparency value is high (more opaque), the color of the overlapped region will be closer to the color of the element with transparency. If the transparency value is low (more transparent), the color of the overlapped region will be closer to the color of the overlapped element. Transparent vector shape filter 313 converts the transparency element and the overlapped element into two new elements with solid fill colors but without the overlapped region. Transparent vector shape filter 313 also creates another new element for the overlapping region with a solid fill color that approximates the original overlapping region.

Transparent image filter 314 is configured to process image elements with transparency. Transparent image filter 314 determines the overlapping region of image elements and creates a new image element that approximates the overlapping region using shape elements and other image elements. Transparent image filter 314 is configured to apply alpha computation and subsequent clipping to polygonal paths.

Converter module 212 may include other filters for performing other processing steps. For example, converter module 212 may include a filter to convert file data to information that a legacy printer can understand, such as page description language (PDL) command streams. Converter module 212 may also include filters that are not configured to modify file data. For example, converter module 212 may include a filter that sends a copy of the file data to an archive.

It is to be understood that filters 311-315 are modularly configured and form a filter pipeline where the output of one filter is served as the input of another filter. The modular configuration enables different filters to be easily added, modified or removed. The filter pipeline enables a file to be converted efficiently to a format understood by a legacy printer. This capability allows converter module 212 to provide a file to a legacy printer for printing without converting the complex elements in the file to computationally-intensive pixel-based elements, such as bitmap elements.

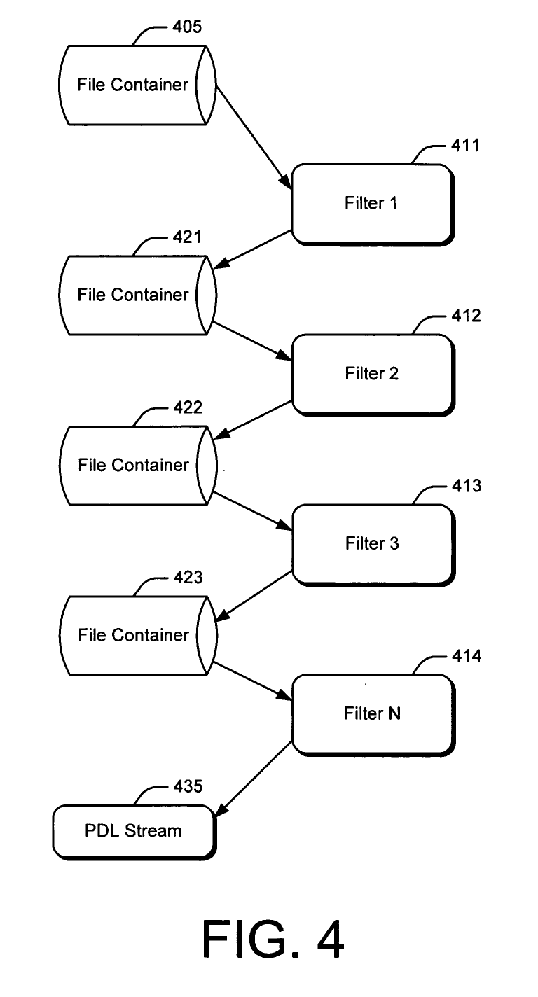

FIG. 4 shows a system for passing file data between filters 411-414 in a filter pipeline. File data is initially stored in filter container 405. Each of the filters 411-414 may be configured to convert the file data. A filter is typically configured to read input file data from a file container and writes output file data to another file container.

As shown in FIG. 4, one implementation is to provide filters 411-414 with file containers 421-423. Each of the file containers 421-423 may be accessed by two filters. Files are typically printed sequentially from page to page. The sequential nature of printing makes it desirable to start processing pages from the file data before all the pages of a job have been written to a file container. To avoid concurrency issues between a producer filter (filter that is writing data) and a consumer filter (filter that is reading data), the file container may be opened with write access by the producer filter and with read-only access by the consumer filter. When the file data has passed through filters 411-414, a print description language (PDL) command stream is created and is sent to a printer.

It is to be appreciated that in this implementation, the resulting document of each filter is written to a new file container. In a filter pipeline with many filters, this implementation would inevitably result in duplicated allocation of disk space needed to hold the complete file container (once for the primary input container at the beginning of the pipeline, and one each to pass data from filter to filter).

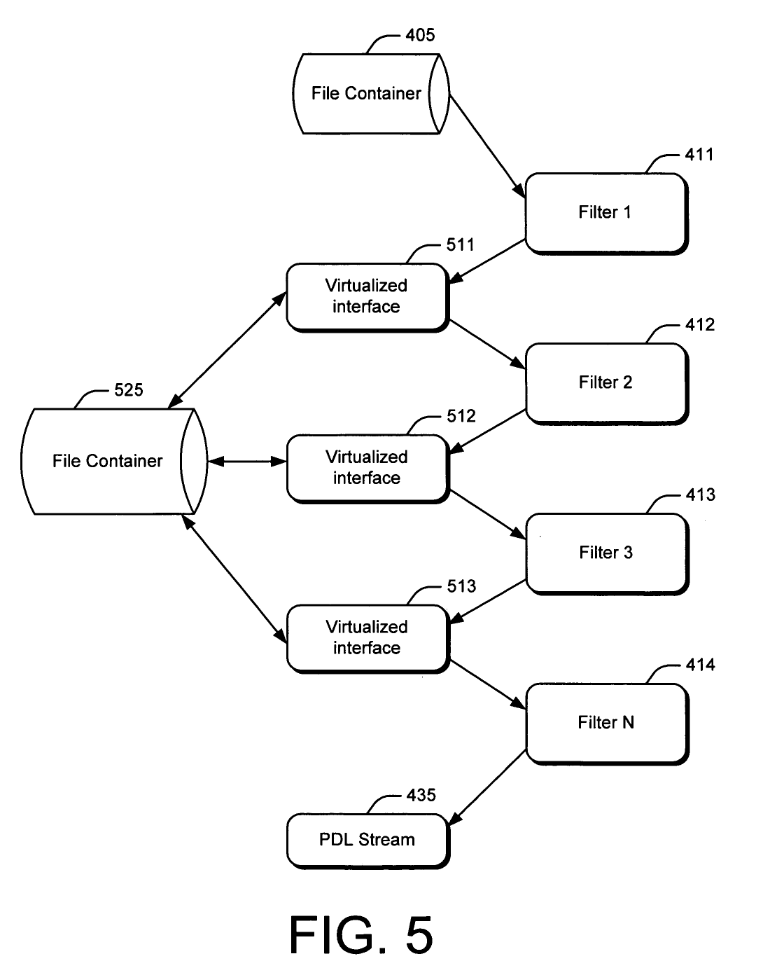

FIG. 5 shows another system for passing file data between filters 411-414 in a filter pipeline. In this implementation, interfaces that provide virtual file containers are used instead of actual file containers. As shown in FIG. 5, filters 411-414 interact with virtualized interfaces 511-513 for reading and writing file data. Each virtualized interface is an application program interface configured to provide a simulated file container to filters 411-414. Through virtualized interfaces 511-513, a filter may obtain pages of a file and write pages as if it is interacting with an actual file container. Virtualized interfaces 511-515 are configured to receive file data from a filter that writes to the simulated file container and to store the file data in memory without creating an actual file container on a disk drive. Virtualized interfaces 511-515 may be configured to store data in any type of memory device. Preferably, virtualized interfaces 511-515 use memory devices that have lower operational overhead than a disk drive. To prevent the exhaustion of memory, virtualized interfaces 511-515 may be configured to create an actual file container 525 when the size of the file data reaches a threshold value.

Virtualized interfaces 511-515 may be configured to store file data of only a few pages at one time in quickly accessible memory. In this manner, filters 411-414 may efficiently read file data through virtualized interfaces 511-515 so that the file data may quickly pass through the filter pipeline without the delays caused by accessing file containers on a disk drive.

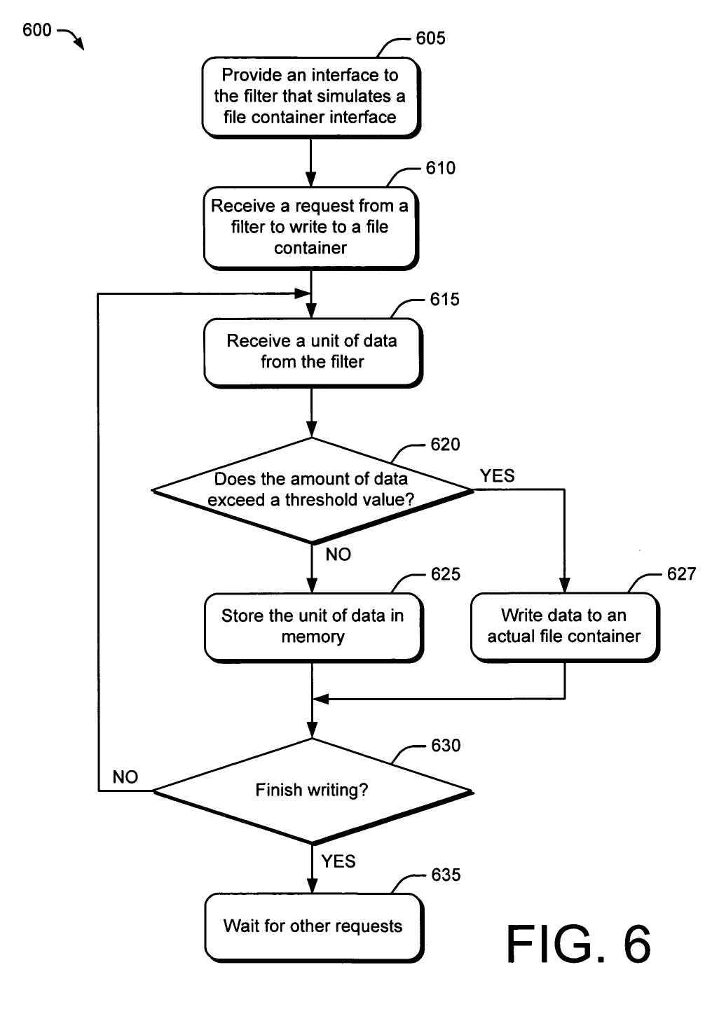

FIG. 6 shows an example process 600 that may be used to provide an interface to filters in a pipeline for writing file data. At block 605, an interface is provided to a filter that simulates a file container interface. At block 610, a request is received from a filter to write to a file container. At block 615, a unit of data is received from the filter. At decision block 620, a determination is made whether the amount of data exceeds a threshold value. If so, process 600 moves to block 627 where data is written to an actual file container. The actual file container may be stored on a disk drive. The process then continues at decision block 630.

Returning to decision block 620, if the amount of data has not exceeded a threshold value, process 600 goes to block 625 where the unit of data is stored in memory. The process then also continues at decision block 630.

At decision block 630, a determination is made whether the filter has finished writing file data. If not, process 600 returns to block 615. If the filter has finished writing file data, process 600 moves to block 635 where the process waits for other requests.

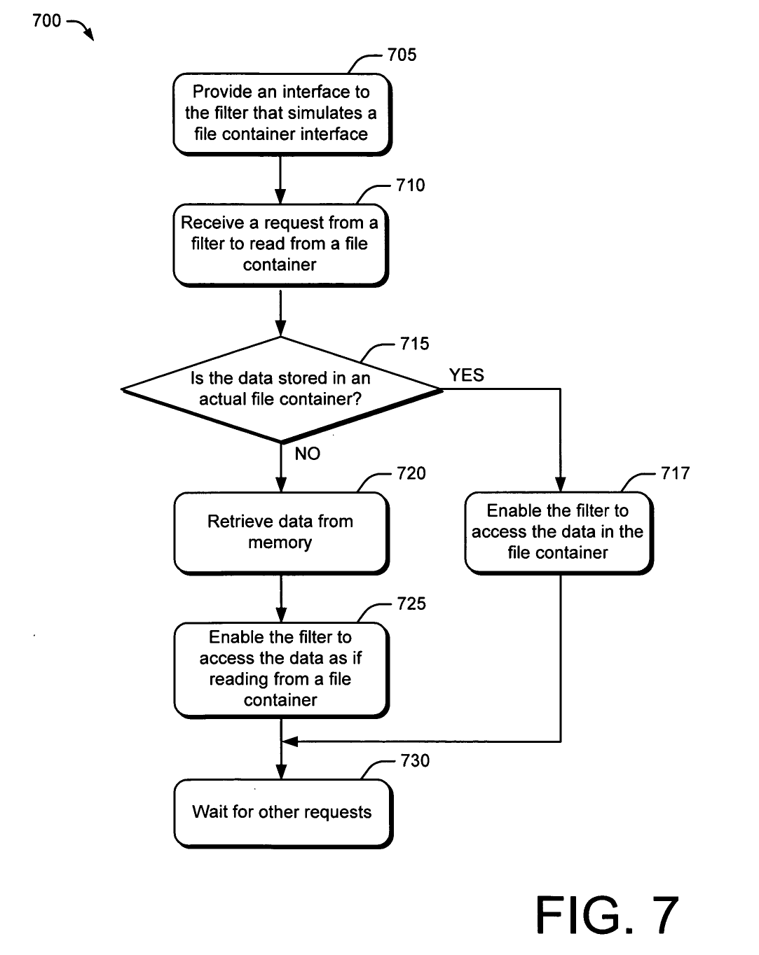

FIG. 7 shows an example process 700 that may be used to provide an interface to filters in a pipeline for reading file data. At block 705, an interface is presented to the filter that simulates a file container interface. At block 710, a request is received from a filter to read from a file container. At decision block 715, a determination is made whether the data is stored in an actual file container. If so, process 700 moves to block 717 where the process enables the filter to access the data in the actual file container. Process 700 then continues at block 730.

Returning to decision block 715, if the data is not stored in an actual file container, then the data is stored in memory. At block 720, the data is retrieved from memory. At block 725, the process enables the filter to access the data as if reading from a file container. At block 730, process 700 waits for other requests.

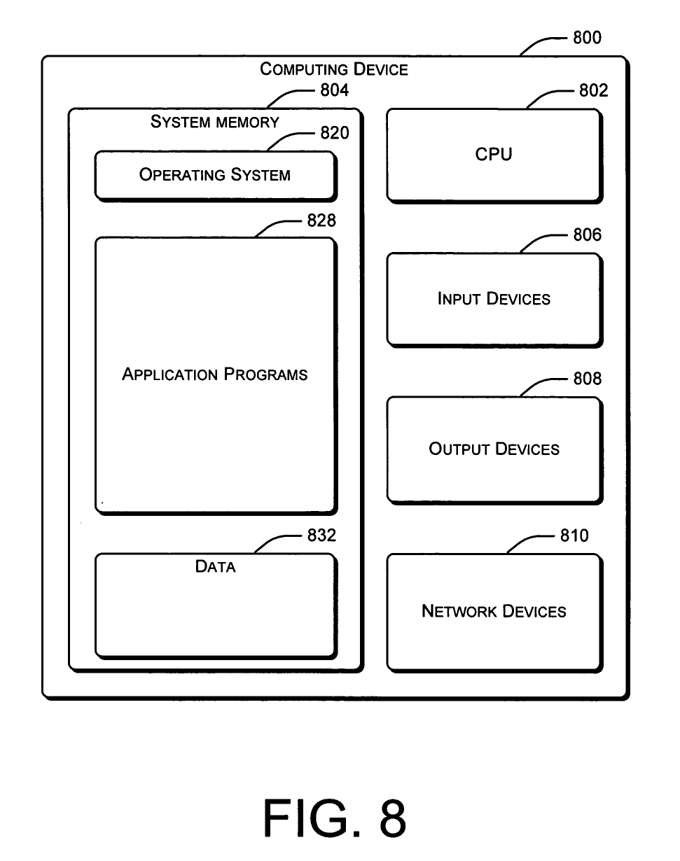

FIG. 8 illustrates an example computing device 800 within which the described systems and methods can be either fully or partially implemented. Computing device 800 is only one example of a computing system and is not intended to suggest any limitation as to the scope of the use or functionality of the invention.

Computing device 800 can be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, gaming consoles, distributed computing environments that include any of the above systems or devices, and the like.

The components of computing device 800 can include, but are not limited to, processors 802 (e.g., any of microprocessors, controllers, and the like), system memory 804, input devices 806, output devices 808, and network devices 810. Processors 802 are not limited by the materials from which they are formed or the processing mechanisms employed therein. For example, processors 802 may be comprised of semiconductor(s) and/or transistors (e.g., electronic integrated circuits (ICs)). In such a context, processor-executable instructions may be electronically-executable instructions. Alternatively, the mechanisms of or for processors 802, and thus of or for computing device 800, may include, but are not limited to, quantum computing, optical computing, mechanical computing (e.g., using nanotechnology), and so forth.

Computing device 800 typically includes a variety of computer-readable media. Such media can be any available media that is accessible by computing device 800 and includes both volatile and non-volatile media, removable and non-removable media. System memory 804 includes computer-readable media in the form of volatile memory, such as random access memory (RAM), and/or non-volatile memory, such as read only memory (ROM). A basic input/output system (BIOS), containing the basic routines that help to transfer information between elements within computing device 800, such as during start-up, is stored in system memory 804. System memory 804 typically contains data and/or program modules that are immediately accessible to and/or presently operated on by processor 802.

System memory 804 can also include other removable/non-removable, volatile/non-volatile computer storage media. By way of example, a hard disk drive may be included for reading from and writing to a non-removable, non-volatile magnetic media; a magnetic disk drive may be included for reading from and writing to a removable, non-volatile magnetic disk (e.g., a “floppy disk”); and an optical disk drive may be included for reading from and/or writing to a removable, non-volatile optical disk such as a CD-ROM, DVD, or any other type of optical media.

The disk drives and their associated computer-readable media provide non-volatile storage of computer-readable instructions, data structures, program modules, and other data for computing device 800. It is to be appreciated that other types of computer-readable media which can store data that is accessible by computing device 800, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement exemplary computing device 800. Any number of program modules can be stored in system memory 804, including by way of example, an operating system 820, application programs 828, and data 832.

Computing device 800 can include a variety of computer-readable media identified as communication media. Communication media typically embodies computer-readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

A user can enter commands and information into computing device 800 via input devices 806 such as a keyboard and a pointing device (e.g., a “mouse”). Other input devices 806 may include a microphone, joystick, game pad, controller, satellite dish, serial port, scanner, touch screen, touch pads, key pads, and/or the like. Output devices 808 may include a CRT monitor, LCD screen, speakers, printers, and the like.

Computing device 800 may include network devices 810 for connecting to computer networks, such as local area network (LAN), wide area network (WAN), and the like.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A system comprising:
filters configured to process data; and
a virtualized interface configured to provide a simulated file container for the filters on which to write the file data, the virtualized interface further configured to enable the filters to read the file data from the simulated file container.

2. The system as recited in claim 1, wherein the filters are included in a file pipeline.

3. The system as recited in claim 2, wherein the filters in the filter pipeline are serially arranged such that output file data of a filter serves as input file data for another filter.

4. The system as recited in claim 1, wherein the file data includes complex elements and wherein at least one of the filters is configured to convert the file data for printing on a legacy printer.

5. The system as recited in claim 1, wherein the filters include at least one of an outline filter, a gradient filter, a transparent vector shape filter, and a transparent image filter.

6. The system as recited in claim 1, wherein the filters includes a filter for converting the file data to page description language (PDL) command streams.

7. The system as recited in claim 1, further comprising a memory device, wherein the virtualized interface is configured to store the file data in the memory device.

8. The system as recited in claim 7, wherein the memory device has a lower operational overhead than a disk drive.

9. The system as recited in claim 7, wherein the memory device includes at least one of volatile memory, random access memory (RAM), and flash memory.

10. The system as recited in claim 1, wherein the virtualized interface is configured to create an actual file container in a disk drive when the size of the file data reaches a threshold value.

11. The system as recited in claim 1, wherein at least one of the filters is configured to start processing a current page from the file data before a previous page have been completely converted for printing on a legacy printer.

12. A method comprising:
providing a virtualized interface to a first filter;
enabling the filter to write file data to a simulated file container provided by the virtualized interface; and
enabling a second filter to read the file data through the virtualized interface.

13. The method as recited in claim 12, further comprising storing the file data in a memory device without creating an actual file container in a disk drive.

14. The method as recited in claim 12, further comprising creating an actual file container in a disk drive when the size of the file data reaches a threshold value.

15. The method as recited in claim 12, wherein the first and second filters are included in a filter pipeline.

16. The method as recited in claim 12, further comprising configuring at least one of the first and second filters to process file data with complex elements for printing on a legacy printer.

17. The method as recited in claim 12, further comprising enabling the second filter to read the file data from the simulated file container provided by the virtualized interface.

18. The method as recited in claim 12, further comprising configuring at least one of the first and second filters to process a current page from the file data before a previous page have been completely converted for printing on a legacy printer.

19. One or more computer-readable memories containing instructions that are executable by a processor to perform the method recited in claim 12.

20. One or more computer-readable media having stored thereon a computer program that, when executed by one or more processors, causes the one or more processors to:
provide an interface to a filter, the interface simulating a file container interface;
receive a request from the filter to write file data in a file container;
receive file data from the filter through the interface; and
store the file data in memory.

21. One or more computer-readable media as recited in claim 20, wherein the computer program further causes the one or more processors to:
determine whether the amount of the file data has exceeded a threshold value; and
if so, write the data to an actual file container in a disk drive.

22. One or more computer-readable media as recited in claim 20, wherein the computer program further causes the one or more processors to:
provide the interface to another filter;
receive a request from the other filter to read the file data in the file container;
retrieve the file data from memory; and
enable the other filter to access the file data through the simulated file container interface.

23. One or more computer-readable media as recited in claim 22, where the filters are included in a filter pipeline.

24. One or more computer-readable media as recited in claim 22, wherein the computer program further causes the one or more processors to:
determine whether the file data is stored in an actual file container in a disk drive; and
if so, enable the other filter to access the file data in the actual file container.

25. An apparatus comprising:
means for providing a virtualized interface to a first filter;
means for enabling the filter to write file data to a simulated file container provided by the virtualized interface; and
means for enabling a second filter to read the file data through the virtualized interface.

26. The apparatus as recited in claim 25, further comprising means for passing file data by storing the data in a memory device without creating an actual file container in a disk drive.

27. The apparatus as recited in claim 25, further comprising means for enabling the second filter to read the file data from the simulated file container provided by the virtualized interface.

28. The apparatus as recited in claim 25, further comprising means for configuring at least one of the first and second filters to process file data with complex elements for printing on a legacy printer.

29. The apparatus as recited in claim 25, further comprising means for configuring at least one of the first and second filters to process a current page from the file data before a previous page have been completely converted for printing on a legacy printer.

30. The apparatus as recited in claim 25, further comprising means for storing file data that incurs a lower operational overhead than a disk drive.
